(19) United States
(12) Patent Application Publication
(10) Pub. No.: US 2012/0138381 A1
(43) Pub. Date: Jun. 7, 2012

(54) STEERING DEVICE FOR AN ELECTRIC VEHICLE

(75) Inventor: Chen-Chi Hsiao, Chiayi Hsien (TW)

(73) Assignee: SUNPEX TECHNOLOGY CO., LTD., Chiayi City (TW)

(21) Appl. No.: 12/958,497

(22) Filed: Dec. 2, 2010

(51) Int. Cl. B62D 5/04; B62D 6/00

(52) U.S. Cl. 180/446

(57) ABSTRACT

A steering device includes: a main body mounted on an electric vehicle; a pivot axle unit mounted rotatably to the main body and having opposite rod portions extending outwardly and respectively from opposite lateral sides of the main body; a control unit coupled to the pivot axle unit for generating a control signal associated with forward or rearward movement of the electric vehicle in response to rotation of the pivot axle unit relative to the main body; and an operating unit operable to drive rotation of the pivot axle unit and including two mounting members that are connected respectively to the rod portions of the pivot axle unit, and a connecting member interconnecting the mounting members. Each mounting member has radially extending operating rods.

### BACKGROUND OF THE INVENTION

1. Field of the Invention

The invention relates to a steering device, and more particularly to a steering device for an electric vehicle.

2. Description of the Related Art

FIG. 1 illustrates a conventional steering device mounted on a vehicle body 100 of an electric vehicle. The conventional steering device includes a main body 11, opposite handgrips 12 connected respectively to left and right sides of the main body 11, and a control unit 13 disposed in the main body 11 and including first and second control rods 131, 132 mounted movably and respectively on the right and left sides of the main body 11. The control unit 13 is operable to generate a first control signal associated with forward movement of the electric vehicle upon movement of the first control rod 131 toward a free end portion 121 of the right handgrip 12, and generate a second control signal associated with rearward movement of the electric vehicle upon movement of the second control rod 132 toward a free end portion 121 of the left handgrip 12.

In use, the conventional steering device is usually operated by both hands of a user. Therefore, it is difficult to operate the conventional steering device using a single hand, especially for a disabled user or an elderly user. Furthermore, both user's hands are limited to holding respectively the free end portions 121 of the handgrips 12 for operation of the right and left control rods 131, 132, thereby resulting in inconvenient operation.

### SUMMARY OF THE INVENTION

Therefore, an object of the present invention is to provide a steering device for an electric vehicle that can overcome the aforesaid disadvantages of the prior art.

According to the present invention, there is provided a steering device for an electric vehicle. The steering device comprises:

a main body adapted to be mounted on a head portion of the electric vehicle and having opposite lateral sides;

a pivot axle unit mounted rotatably to the main body and having opposite rod portions extending outwardly and respectively from the lateral sides of the main body in a transverse direction;

a control unit disposed in the main body and coupled to the pivot axle unit, the control unit being operable to generate a control signal in response to rotation of the pivot axle unit relative to the main body about an axis parallel to the transverse direction, the control signal being associated with forward or rearward movement of the electric vehicle; and

an operating unit operable to drive rotation of the pivot axle unit and including two mounting members that are connected respectively to the rod portions of the pivot axle unit, and a connecting member that interconnects the mounting members, each of the mounting members having at least one radially extending operating rod.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional steering device for an electric vehicle;

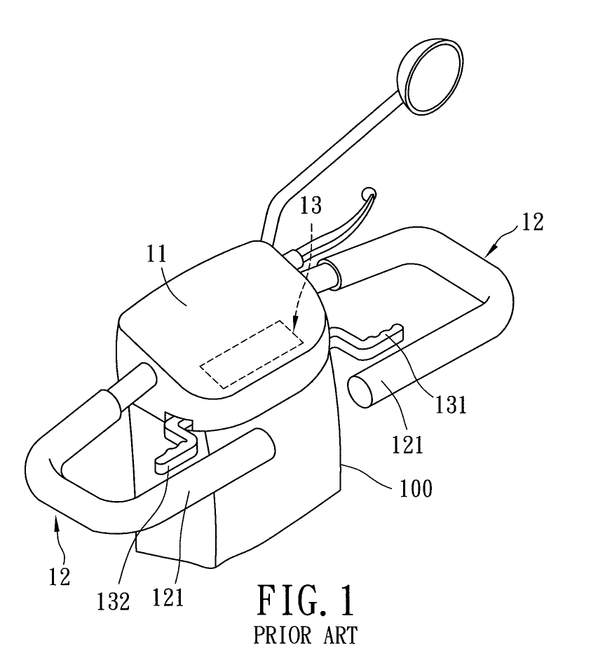

FIG. 2 is a perspective view showing the preferred embodiment of a steering device for an electric vehicle according to the present invention;

FIG. 3 is a schematic circuit block diagram illustrating the preferred embodiment;

FIG. 4 is a schematic top view showing the preferred embodiment;

FIG. 5 is a schematic side view showing the preferred embodiment; and

FIG. 6 is another schematic side view showing the preferred embodiment when an operating unit rotates.

### DETAILED DESCRIPTION OF THE PREFERRED EMBODIMENT

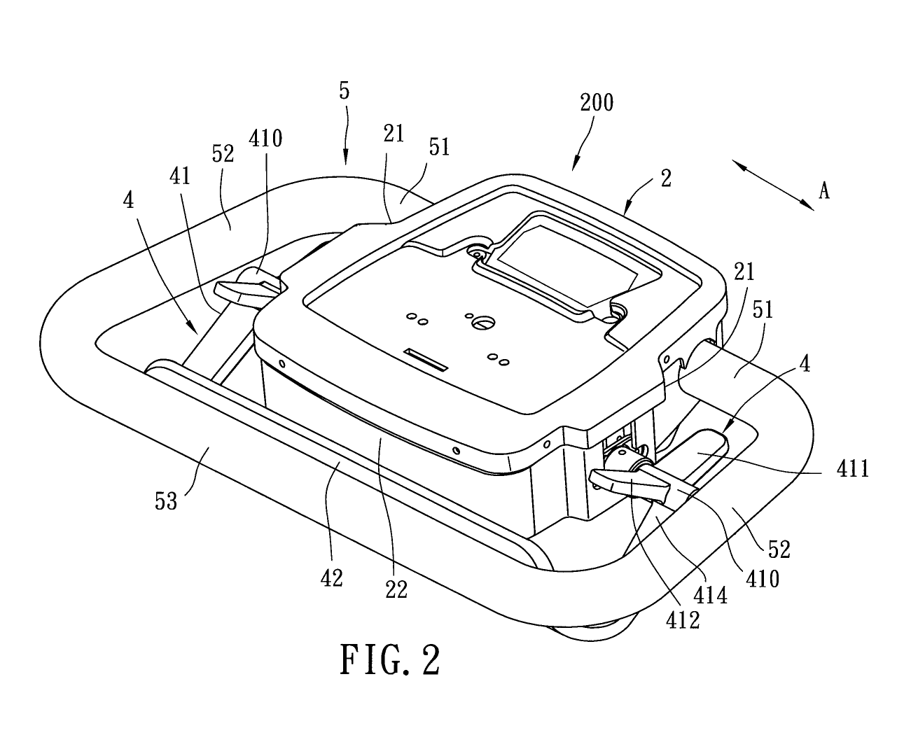

Referring to FIGS. 2 to 5, the preferred embodiment of a steering device for an electric vehicle according to the present invention is shown to include a main body 2, a handgrip 5, a pivot axle unit 3, a control unit 6, and an operating unit 4.

The main body 2 is adapted to be mounted on a head portion of a vehicle body (not shown), and has opposite lateral sides 21.

In this embodiment, the handgrip 5 has two first sections 51, two second sections 52 and a third section 53. The first sections 51 are connected respectively to the lateral sides 21 of the main body 2 and extending in a transverse direction (A). The second sections 52 are spaced respectively apart from the lateral sides 21 of the main body 2, and are connected respectively to the first sections 51. The third section 53 extends in the transverse direction (A), and interconnects the second sections 52. The third section 53 is disposed adjacent to a rear side 22 of the main body 2.

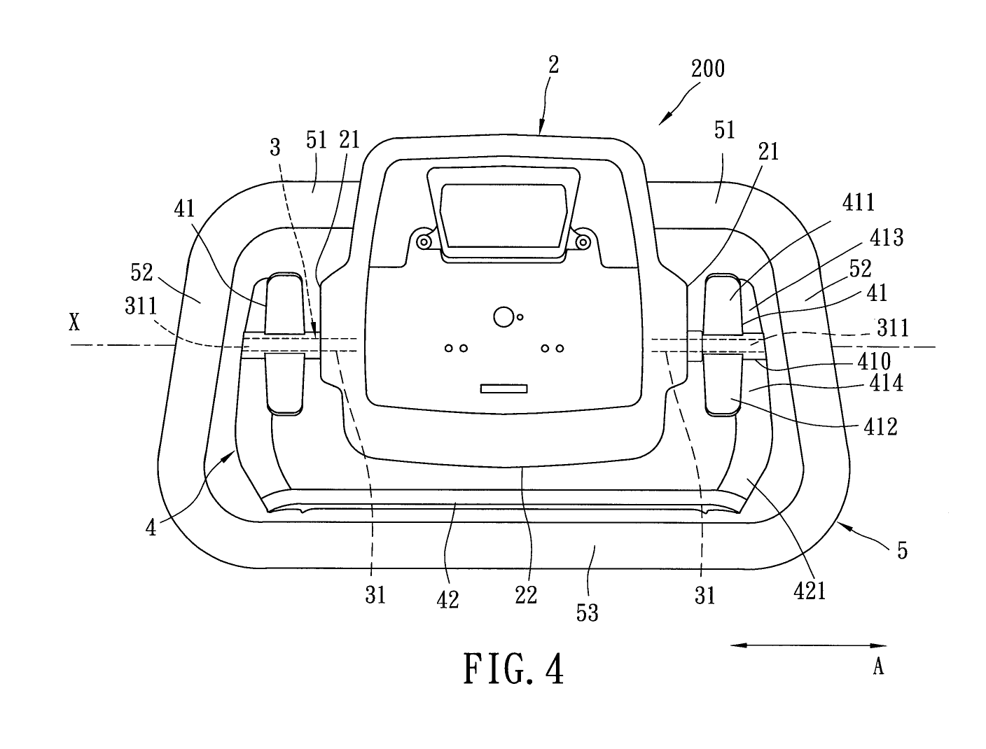

As shown in FIG. 4, the pivot axle unit 3 is mounted rotatably to the main body 2, and has opposite rod portions 311 extending outwardly and respectively from the lateral sides 21 of the main body 2 in the transverse direction (A). In this embodiment, the pivot axle unit 3 includes two pivot rods 31 mounted in the main body 2. Each pivot rod 31 has an end portion that is exposed at a corresponding lateral side 21 of the main body 2 and that serves as a corresponding rod portion 311.

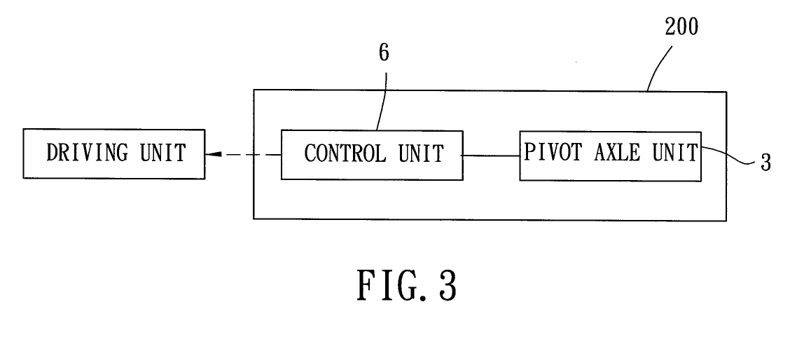

The control unit 6 is disposed in the main body 2, and is coupled to the pivot axle unit 3. The control unit 6 is operable to generate a control signal in response to rotation of the pivot axle unit 3 relative to the main body 2 about an axis (X) parallel to the transverse direction (A). The control signal is associated with forward or rearward movement of the electric vehicle. In this embodiment, the control signal generated by the control unit 6 is output to a driving unit for driving movement of the electric vehicle (see FIG. 3) such that the driving unit drives forward or rearward movement of the electric vehicle based on the control signal. For example, when the pivot axle unit 3 rotates about the axis (X) in a clockwise direction, the driving unit drives the electric vehicle to move forward based on the control signal generated by the control unit 6 in response to clockwise rotation of the pivot axle unit 3. When the pivot axle unit 3 rotates about the axis (X) in a counterclockwise direction, the driving unit drives the electric vehicle to move rearward based on the control signal generated by the control unit 6 generated by the control unit 6 in response to counterclockwise rotation of the pivot axle unit 3.

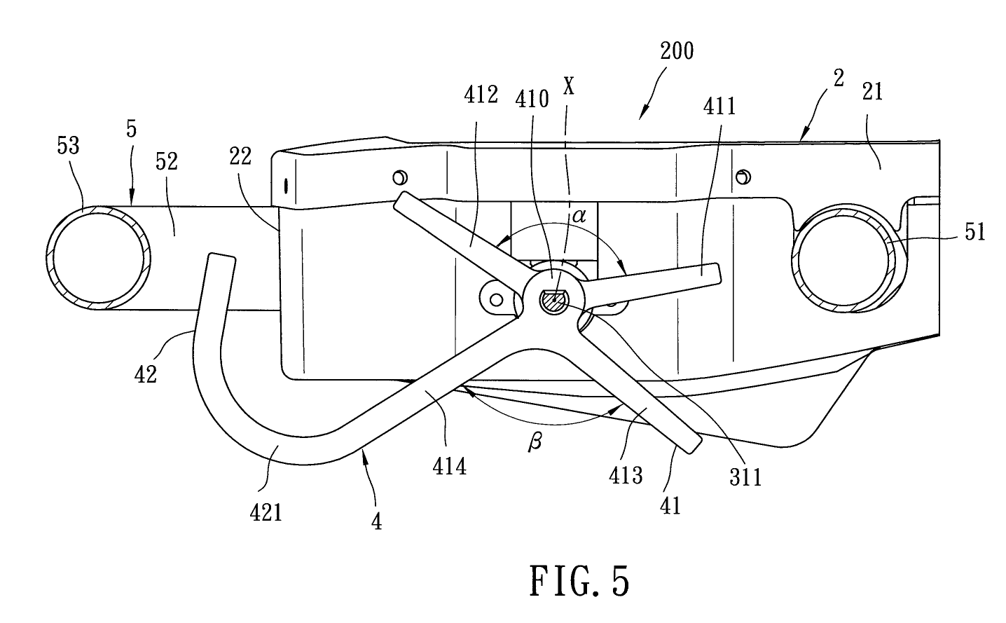

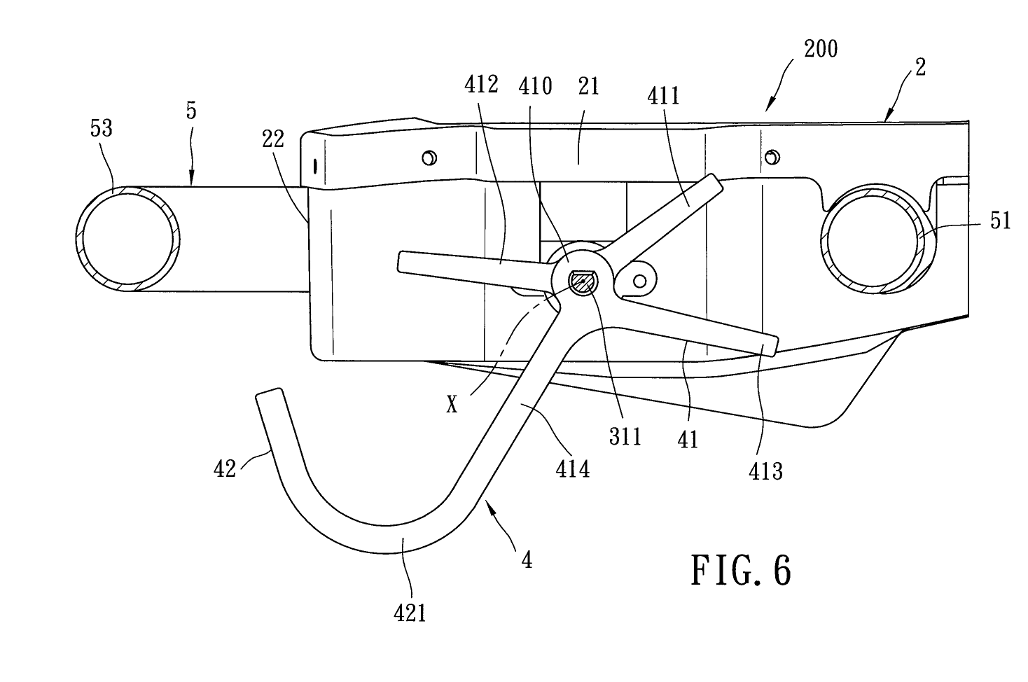

The operating unit 4 is operable to drive rotation of the pivot axle unit 3, and includes two mounting members 41 and a connecting member 42. The mounting members 41 are connected respectively to the rod portions 311 of the pivot axle unit 3, and are disposed respectively adjacent to the second sections 52 of the handgrip 5. In this embodiment, as shown in FIGS. 5 and 6, each mounting member 41 has a sleeve body 410 sleeved fixedly on a corresponding rod portion 311 of the pivot axle unit 3, and four extending operating rods 411, 412, 413, 414 extending radially and outwardly from the sleeve body 410, wherein the operating rods 411, 412 extend upwardly toward a corresponding first section 51 and the third section 53 of the handgrip 5, respectively, and the operating rods 413, 414 extend downwardly toward the corresponding first section 51 and the third section 53 of the handgrip 5, respectively. For each mounting member 41, a first angle (α) is formed between the operating rods 411, 412 and ranges from 130° to 150°, and a second angle (β) is formed between the operating rods 413, 414 and ranges from 100° to 120°. In this embodiment, the first and second angles (α, β) are 140° and 110°, respectively. The connecting member 42 interconnects the mounting members 41, and is disposed adjacent to the third section 53 of the handgrip 5. In this embodiment, the connecting member 42 is in the form of an inverted U-shaped rod that has opposite curved ends 421 connected integrally and respectively to the operating rods 414 of the mounting members 41.

In use, any of the operating rods 411, 412, 413, 414 of the mounting member 41, and the connecting member 41, i.e., the inverted U-shaped rod, can be operated to drive the pivot axle unit 3 to rotate in the clockwise or counterclockwise direction. Therefore, the steering device 200 of the present invention is easily controlled by a single user's hand holding the handgrip 5 at any position, thereby resulting in convenient operation.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A steering device for an electric vehicle comprising:
a main body adapted to be mounted on a vehicle body of the electric vehicle and having opposite lateral sides;
a pivot axle unit mounted rotatably to said main body and having opposite rod portions extending outwardly and respectively from said lateral sides of said main body in a transverse direction;
a control unit disposed in said main body and coupled to said pivot axle unit, said control unit being operable to generate a control signal in response to rotation of said pivot axle unit relative to said main body about an axis parallel to the transverse direction, the control signal being associated with forward or rearward movement of the electric vehicle; and
an operating unit operable to drive rotation of said pivot axle unit and including two mounting members that are connected respectively to said rod portions of said pivot axle unit, and a connecting member that interconnects said mounting members, each of said mounting members having at least one radially extending operating rod.

2. The steering device as claimed in claim 1, wherein each of said mounting members of said operating unit has a sleeve body sleeved fixedly on a corresponding one of said rod portions of said pivot axle unit, and four said operating rods, two of said operating rods extending outwardly and upwardly from said sleeve body and forming a first angle therebetween, the other ones of said operating rods extending outwardly and downwardly from said sleeve body and forming a second angle therebetween.

3. The steering device as claimed in claim 2, wherein the first angle ranges from 130° to 150°, and the second angle ranges from 100° to 120°.

4. The steering device as claimed in claim 2, wherein said connecting member of said operating unit includes an inverted U-shaped rod having opposite ends each connected to one of the other ones of said operating rods of a corresponding one of said mounting members.

5. The steering device as claimed in claim 2, further comprising a handgrip having two first sections connected respectively to said lateral sides of said main body, two second sections spaced respectively apart from said lateral sides of said main body, connected respectively to said first sections, and disposed respectively adjacent to said mounting members of said operating unit, and a third section interconnecting said second sections, and disposed adjacent to said connecting member of said operating unit.

6. The steering device as claimed in claim 1, wherein said pivot axle unit includes two pivot rods mounted in said main body, each of said pivot rods having an end portion that is exposed from a corresponding one of said lateral sides of said main body and that serves as a corresponding one of said rod portions.
